(19) United States
(12) Patent Application Publication
(10) Pub. No.: US 2016/0117855 A1
(43) Pub. Date: Apr. 28, 2016

(54) RENDERING APPARATUS AND METHOD

(71) Applicant: Samsung Electronics Co., Ltd., Suwon-si (KR)

(72) Inventors: Wonjong LEE, Seoul (KR); Youngsam SHIN, Hwaseong-si (KR); SeokJoong HWANG, Seoul (KR)

(73) Assignee: SAMSUNG ELECTRONICS CO., LTD., Suwon-si (KR)

(21) Appl. No.: 14/793,353

(22) Filed: Jul. 7, 2015

(30) Foreign Application Priority Data
Oct. 22, 2014 (KR) 10-2014-0143601

(51) Int. Cl. G06T 15/00; G06T 11/00; G06T 11/40; G06T 15/06

(52) U.S. Cl. CPC G06T 15/005; G06T 15/06; G06T 11/001; G06T 11/40; G06T 2210/12; G06T 2207/10024

(57) ABSTRACT

A rendering apparatus includes a tile binning unit configured to determine a plurality of tiles including at least one primitive, and configured to generate tile data associated with the plurality of tiles. The rendering apparatus includes a visibility test unit configured to perform a visibility test on the at least one primitive included in the plurality of tiles, based on the tile data. The rendering apparatus further includes a rendering unit configured to perform rendering on a visible primitive among the at least one primitive as a result of the visibility test.

### CROSS-REFERENCE TO RELATED APPLICATIONS

This application claims the benefit of Korean Patent Application No. 10-2014-0143601, filed on Oct. 22, 2014, in the Korean Intellectual Property Office, the disclosure of which is incorporated herein in its entirety by reference.

### BACKGROUND

1. Field

The present disclosure relates to a rendering apparatus and method, and more particularly, to a rendering apparatus and method for performing visibility examination on a primitive.

2. Description of the Related Art

In general, 3-dimensional (3D) rendering refers to image processing in which 3D object data is synthesized into an image that is shown at a given camera viewpoint.

Examples of a rendering method include a rasterization method that generates an image by projecting a 3D object onto a screen, and a ray tracing method that generates an image by tracing the path of light that is incident along a ray traveling toward each image pixel at a camera viewpoint.

The rasterization method includes immediate mode rendering that immediately performs rendering whenever a primitive of object data occurs in a geometrical processing operation, and tile-based rendering that performs rendering in an order of virtual tiles split from a frame.

### SUMMARY

A rendering apparatus and method for performing visibility examination on a primitive are provided, thereby removing unnecessary calculation and reducing power consumption.

Additional aspects will be set forth in part in the description which follows and, in part, will be apparent from the description, or may be learned by practice of the presented embodiments.

According to an aspect, a rendering apparatus includes: a tile binning unit configured to determine a plurality of tiles including at least one primitive, and configured to generate tile data associated with the plurality of tiles; a visibility test unit configured to perform a visibility test on the at least one primitive included in the plurality of tiles, based on the tile data; and a rendering unit configured to perform rendering on a visible primitive among the at least one primitive as a result of the visibility test.

The visibility test unit may be configured to generate a ray with respect to each pixel among a plurality of pixels included in a respective tile among the plurality of tiles, perform an intersection test on the generated ray and a primitive, among the at least one primitive, included in the respective tile, and determine whether the primitive included in the respective tile is visible.

The visibility test unit may be configured to obtain at least one of primitive information about one or more primitives, among the at least one primitive, which the ray intersects, and a depth value of a point which the ray intersects.

The rendering apparatus may further include a tag buffer configured to store the primitive information about the one or more primitives which the ray intersects.

The rendering apparatus may further include a depth buffer configured to store the depth value of the point which the ray intersects.

The rendering apparatus may further include an acceleration structure generation unit configured to generate an acceleration structure with respect to each tile of the plurality of tiles. The visibility test unit may be configured to perform the visibility test on the at least one primitive included in the plurality of tiles based on the generated acceleration structure.

The rendering unit may include a rasterizer configured to split the visible primitive into fragments, and a pixel shader configured to determine color values of the split fragments.

The rendering unit may further include a depth test unit configured to perform a depth test on the split fragments.

The visibility test unit may be configured to generate a ray with respect to each pixel among a plurality of pixels included in a respective tile among the plurality of tiles, perform an intersection test on the generated ray and a primitive, among the plurality of primitives, included in the respective tile, and obtain a depth value of a point which the ray intersects. The depth test unit may be configured to perform a depth test on the split fragments based on the depth value of the point which the ray intersects.

According to another aspect, a rendering method includes: determining, using at least one processor, a plurality of tiles including at least one primitive; generating, using the at least one processor, tile data associated with the plurality of tiles; performing, using the at least one processor, a visibility test on the at least one primitive included in the plurality of tiles based on the tile data; and performing, using the at least one processor, rendering on a visible primitive among the at least one primitive as a result of the visibility test.

A computer-readable recording medium may have a program recorded thereon and configured to execute the rendering method.

The performing of the visibility test may include: generating a ray with respect to each pixel among a plurality of pixels included in a respective tile among the plurality of tiles; performing an intersection test on the generated ray and a primitive, among the at least one primitive, included in the respective tile; and determining whether the primitive included in the respective tile is visible.

The performing of the visibility test may include obtaining at least one of primitive information about one or more primitives, among the at least one primitive, which the ray intersects, and a depth value of a point which the ray intersects.

The rendering method may further include storing the primitive information about the one or more primitives which the ray intersects.

The rendering method may further include storing the depth value of the point which the ray intersects.

The rendering method may further include: generating, using the at least one processor, an acceleration structure with respect to each tile of the plurality of tiles. The performing of the visibility test may include performing the visibility test on the at least one primitive included in the plurality of tiles based on the generated acceleration structure.

The performing of the rendering may include splitting the visible primitive into fragments and determining color values of the split fragments.

The performing of the rendering may further include performing a depth test on the split fragments.

The performing of the visibility test may include: generating a ray with respect to each pixel among a plurality of pixels included in a respective tile among the plurality of tiles; performing an intersection test on the generated ray and a primitive, among the at least one primitive, included in the respective tile; obtaining a depth value of a point which the ray intersects; and performing the depth test on the split fragments based on the depth value of the point which the ray intersects.

According to another aspect, a rendering apparatus includes: a tile binning unit configured to generate tile data associated with a plurality of tiles including a plurality of primitives; a visibility test unit configured to perform, based on the tile data, a visibility test on the plurality of primitives in order to determine which primitives among the plurality of primitives are visible primitives; and a rendering unit configured to perform rendering on the visible primitives only.

The visibility test unit may be configured to perform the visibility test based on ray tracing.

### BRIEF DESCRIPTION OF THE DRAWINGS

These and/or other aspects will become apparent and more readily appreciated from the following description of example embodiments, taken in conjunction with the accompanying drawings in which:

FIG. 1 is a diagram illustrating a process of rendering a 3D image according to an embodiment;

FIG. 2 is a block diagram illustrating a structure of a rendering apparatus according to an embodiment;

FIG. 3 is a diagram illustrating a tile binning method according to an embodiment;

FIGS. 4A and 4B are reference diagrams illustrating a visibility test method performed on a primitive according to an embodiment;

FIG. 5 is a block diagram illustrating a structure of a rendering apparatus according to another embodiment;

FIG. 6 is a block diagram illustrating a structure of a rendering system according to an embodiment;

FIG. 7 is a block diagram illustrating a structure of a rendering apparatus according to another embodiment;

FIGS. 8A and 8B are diagrams of an acceleration structure corresponding to a tile according to an embodiment;

FIG. 9 is a flowchart illustrating a rendering method according to an embodiment;

FIG. 10 is a flowchart illustrating an operation of FIG. 9 according to an embodiment; and

FIG. 11 is a flowchart illustrating an operation of FIG. 9 according to an embodiment.

### DETAILED DESCRIPTION

Reference will now be made in detail to embodiments, examples of which are illustrated in the accompanying drawings, wherein like reference numerals refer to like elements throughout. In this regard, the disclosed embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having meanings that are consistent with their meanings in the context of the relevant art and will not be interpreted in an idealized or overly formal sense unless expressly so defined herein.

When a part may “include” a certain constituent element, unless specified otherwise, it may not be construed to exclude another constituent element but may be construed to further include other constituent elements. Terms such as “˜portion”, “˜unit”, “˜module”, and “˜block” stated in the specification may signify a unit to process at least one function or operation and the unit may be embodied by hardware, software, or a combination of hardware and software. Also, as a computer software command to embody the invention, hardware, software, or a combination of hardware and software may be used instead of a programmed processor/controller. Accordingly, the present invention is not limited by a specific combination of hardware and software.

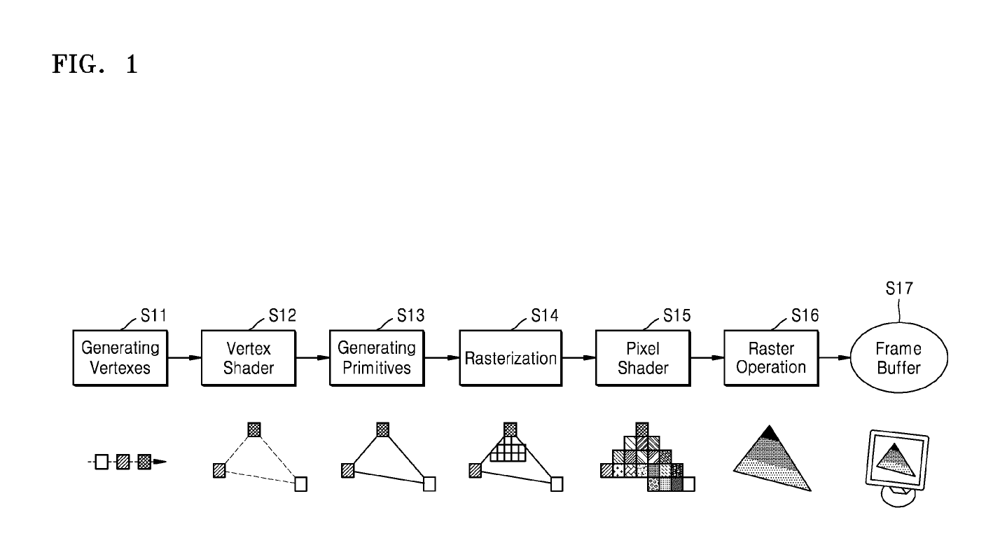

FIG. 1 is a diagram for explaining a process of rendering a 3D image according to an embodiment.

Referring to FIG. 1, the process of rendering the 3D image b may include operations S11 through S17. Figures along the bottom of FIG. 1 conceptually show processing of a vertex or a pixel in each operation.

Operation S11 generates vertexes indicating images. The vertexes are generated to indicate objects included in the images.

Operation S12 shades the generated vertexes. More specifically, a vertex shader may designate colors of the vertexes generated in operation S11 to perform shading on the vertexes.

Operation S13 generates primitives indicating a polygon formed from a point, a line, or the vertexes. By way of example, the primitives may indicate triangles formed by connecting the vertexes.

Operation S14 rasterizes the primitives by splitting the primitives into a plurality of fragments. A fragment may be a unit forming a primitive and may be a basic unit for processing an image. The primitives include information regarding the vertexes. Thus, interpolation may be performed when the fragments between the vertexes are generated in operation S14.

Operation S15 shades a pixel. Although shading is performed in a pixel shader in FIG. 1, shading may be performed in a fragment unit. For example, shading of a pixel or a fragment designates a color of the pixel or the fragment.

Operation S16 performs a raster operation in which color blending, depth examination, etc. are performed, thereby generating a raster image (pixels or samples) based on information regarding the shaded pixel. The generated raster image is output as a frame buffer.

In operation S17, the frame generated in operations S11 through S16 is stored in a frame buffer and displayed on a display apparatus.

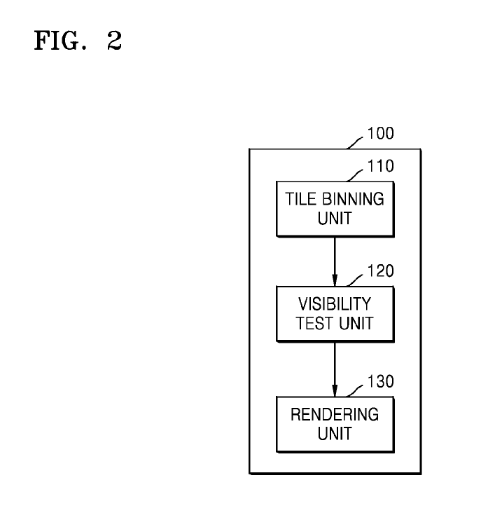

FIG. 2 is a block diagram illustrating a structure of a rendering apparatus 100 according to an embodiment.

Referring to FIG. 2, the rendering apparatus 100 includes a tile binning unit 110, a visibility test unit 120, and a rendering unit 130.

The tile binning unit 110 splits a 2D frame into a plurality of tiles and bins the tiles. Tile binning includes discrimination of tiles including at least one primitive.

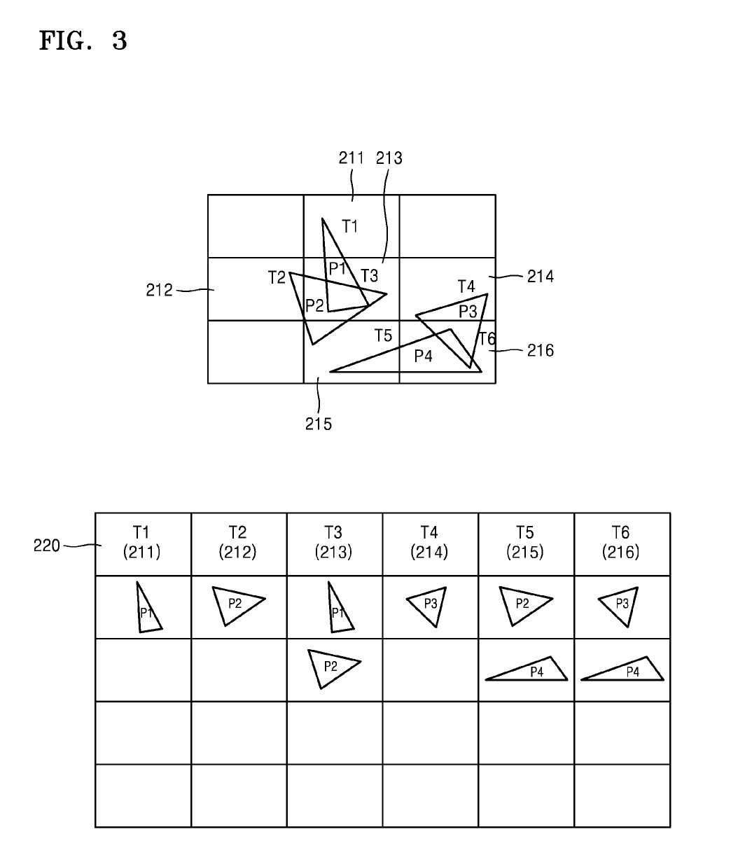

For example, as shown in FIG. 3, the 2D frame may include nine (9) tiles among which six (6) tiles 211, 212, 213, 214, 215, and 216 may include the at least one primitive. Referring to FIG. 3, a first primitive P1 is included in the tile T1 (211) and the tile T3 (213), and a second primitive P2 is included in the tile T2 (212), the tile T3 (213), and the tile T5 (215). A third primitive P3 is included in the tile T4 (214) and the tile T6 (216), and a fourth primitive P4 is included in the tile T5 (215) and the tile T6 (216). The tile binning unit 110, as described above, may determine which tile(s) of the plurality of tiles (T1-T6) include(s) a respective primitive (P1, P2, P3), and, as shown in FIG. 2, may generate tile data 220 including information regarding primitive(s) included in the tile(s).

The visibility test unit 120 performs a visibility test on the primitives included in the plurality of tiles. For example, the visibility test unit 120 may perform the visibility test on the primitive(s) included in a respective tile by using a ray tracing method.

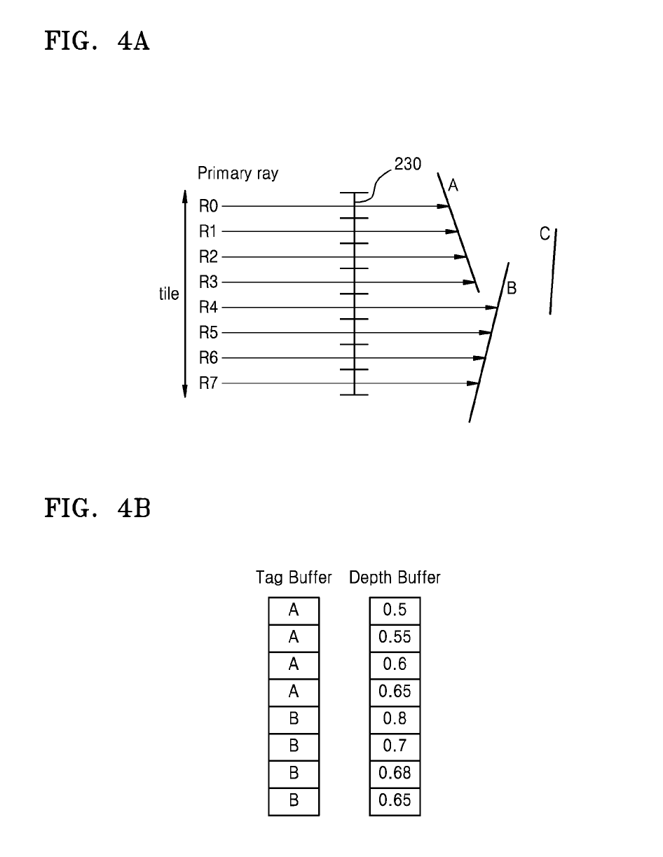

The visibility test method will be described in more detail with reference to FIGS. 4A and 4B below.

FIGS. 4A and 4B are reference diagrams for explaining a visibility test method performed on a primitive according to an embodiment.

Referring to FIG. 4A, the visibility test unit 120 may generate a primary ray (R0-R7) with respect to each pixel among a plurality of pixels included in a tile. For example, the visibility test unit 120 may generate a first ray RO through an eighth ray R7, respectively, with respect to first through eighth pixels. The visibility test unit 120 may perform an intersection test on the generated first ray R0 and primitives included in the corresponding tile to detect a primitive with which the first ray R0 intersects according to the pixels.

As shown in FIG. 4A, the visibility test unit 120 performs intersection tests to determine which one of primitives A, B, and C included in the tile each of first through eighth rays R0, R1, R2, R3, R4, R5, R6, and R7 intersects. For example, the visibility test unit 120 may detect the first primitive A which the first through fourth rays R0, R1, R2, and R3 intersect and the second primitive B with which the fifth through eighth rays R4, R5, R6, and R7 intersect. The visibility test unit 120 may determine that the first ray RO does not intersect the third primitive C. The visibility test unit 120 may perform intersection tests for every tile that includes a primitive.

Accordingly, the visibility test unit 120 may detect at least one visible primitive from among a plurality of primitives (for example, the first through third primitives A, B, and C) included in the tile. The visible primitives may be stored in a tag buffer.

The visibility test unit 120 may calculate a distance (a depth value of an intersection point) from a frame 230 to an intersection point of the primary ray R0-R7 and the primitive according to the pixels. In this regard, depth values of intersection points calculated according to the pixels may be stored in a depth buffer. The depth values stored in the depth buffer may be used to render the primitive.

The rendering unit 130 performs rendering on the visible primitives. For example, in the tiles of FIGS. 4A and 4B, the rendering unit 130 may perform rendering only on the visible first primitive A and the visible second primitive B among the first through third primitives A, B, and C, and may not perform rendering on the invisible third primitive C.

The rendering unit 130 splits the visible first primitive A and the visible second primitive B into a plurality of fragments and performs pixel shading for determining color values of the split fragments. The rendering unit 130 performs a depth test on the split fragments. For example, the rendering unit 130 may perform a depth test on the split fragments by using the depth values calculated by the visibility test unit 120. The rendering unit 130 may compare depth values of the fragments and the depth values calculated by the visibility test unit 120 to test whether a corresponding fragment is visible. The rendering unit 130 may perform pixel shading on the visible first primitive A and the visible second primitive B.

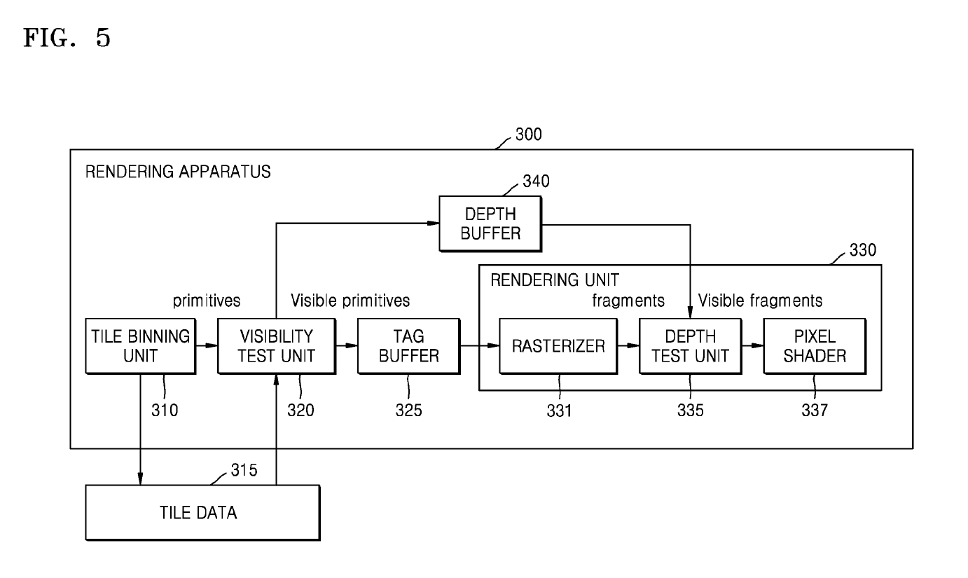

FIG. 5 is a block diagram illustrating a structure of a rendering apparatus 300 according to another embodiment.

The rendering apparatus 300 includes a tile binning unit 310, a visibility test unit 320, a tag buffer 325, a depth buffer 340, and a rendering unit 330. The rendering unit 330 includes a rasterizer 331, a depth test unit 335, and a pixel shader 337. The tile binning unit 310, the visibility test unit 320, and the rendering unit 330 of FIG. 5 respectively correspond to the tile binning unit 110, the visibility test unit 120, and the rendering unit 130 of FIG. 2.

The tile binning unit 310 bins a plurality of tiles included in a 2D frame based on information regarding primitives. The tile binning unit 310 determines which one of the plurality of tiles includes the primitives, and as described with reference to FIG. 3 above, generates tile data 315 including information regarding a primitive included in each tile. The tile data 315 may be stored in an external memory.

The visibility test unit 320 may perform a visibility test on the primitive(s) included in a respective tile by using a ray tracing method. The visibility test using the ray tracing method is described in detail with reference to FIGS. 4A and 4B, and thus a detailed description is omitted.

The visibility test unit 320 outputs visible primitive information to the tag buffer 325 as a result of the visibility test. The tag buffer 325 stores primitive information about a primitive which the ray intersects with respect to pixels included in the tiles. For example, as shown in FIGS. 4A and 4B, the tag buffer 325 may store the primitive intersection information corresponding to a corresponding pixel.

The visibility test unit 320 calculates a distance (a depth value of an intersection point) from a frame to an intersection point of a primary ray and the primitive with respect to pixels included in the tiles. In this regard, depth values of intersection points calculated for each pixel may be stored in the depth buffer 340. For example, as shown in FIGS. 4A and 4B, the depth buffer 340 may store the depth values of the intersection points corresponding to the corresponding pixels.

The tag buffer 325 outputs the visible primitive information to the rasterizer 331. The rasterizer 331 splits the primitives output by the tag buffer 325 into fragments and outputs the split fragments to the depth test unit 335.

The depth test unit 335 performs a depth test on the fragments. For example, the depth test unit 335 may perform a depth test on the split fragments by using the depth values calculated by the visibility test unit 335. The depth test unit 335 compares the depth values stored in the depth buffer 340 and depth values of the fragments to determine whether to test whether a corresponding fragment is visible. For example, when the depth values of the fragments are identical to the depth values stored in the depth buffer 340, the depth test unit 335 may determine the corresponding fragment as a visible fragment, but is not limited such operation.

The depth test unit 335 outputs the visible fragment to the pixel shader 337. The pixel shader 337 performs pixel shading for determining a color value of the output fragment (pixel).

Although not shown in FIG. 5, the rendering unit 330 may further include a raster operation (ROP) unit. The ROP unit may perform an alpha test of testing an alpha value indicating transparency of each pixel. The alpha value of each pixel may be used to perform alpha blending, which is one of methods of expressing a transparent effect of an object. The ROP unit may perform color blending of designating an accurate color of each pixel by using an RGB color of a pixel and an alpha value indicating transparency of the pixel, but is not limited to such operation.

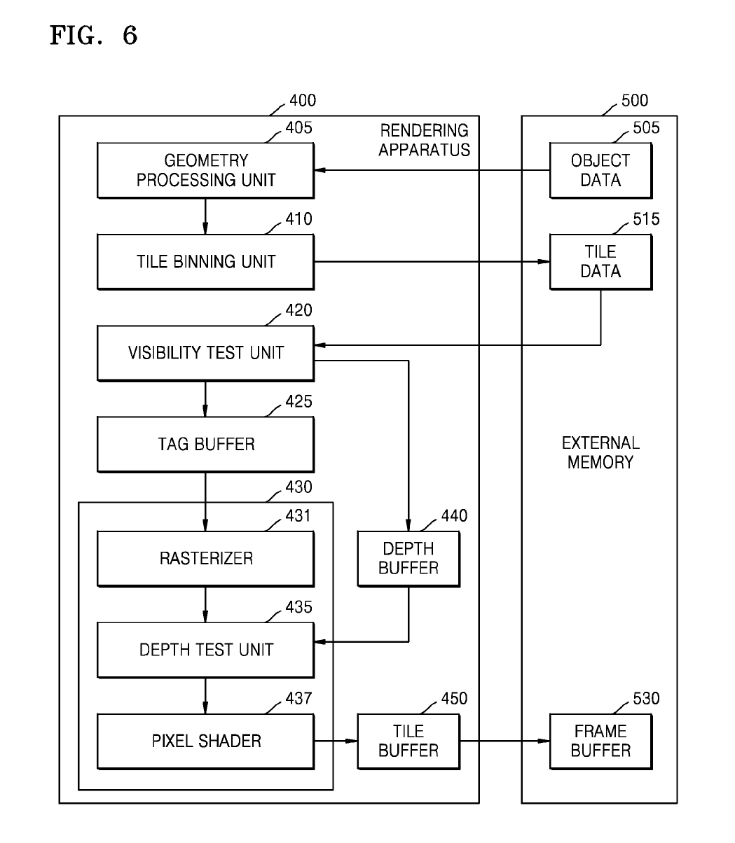

FIG. 6 is a block diagram illustrating a structure of a rendering system according to an embodiment.

Referring to FIG. 6, the rendering system includes a rendering apparatus 400 and an external memory 500.

The rendering apparatus 400 includes a geometry processing unit 405, a tile binning unit 410, a visibility test unit 420, a tag buffer 425, a rendering unit 430, a depth buffer 440, and a tile buffer 450.

The external memory 500 stores object data 505 and tile data 515, and may include a frame buffer 530.

Meanwhile, the tile binning unit 410, the visibility test unit 420, the tag buffer 425, the rendering unit 430, and the depth buffer 440 of FIG. 6 may correspond to the tile binning unit 310, the visibility test unit 320, the tag buffer 325, the rendering unit 330, and the depth buffer 340 of FIG. 5. The binning unit 410, the visibility test unit 420, the tag buffer 425, the rendering unit 430, and the depth buffer 440 are described in detail with reference to FIG. 5, and thus detailed descriptions thereof are omitted.

Referring to FIG. 6, the geometric processing unit 405 generates vertexes by using the object data 505 stored in the external memory 500. The geometry processing unit 405 generates primitives included in an object by using the vertexes, and outputs information regarding the primitives to the tile binning unit 410.

The tile binning unit 410 bins a plurality of tiles included in a 2D frame based on information regarding the primitives. The tile binning unit 410 may store the tile data 515 in the external memory 500.

The visibility test unit 420 performs a visibility test on the primitive included in each of the plurality of tiles by using the tile data 515. The visibility test unit 420 outputs visible primitive information to the tag buffer 425 as a result of the visibility test.

The visibility test unit 420 calculates a distance (a depth value of an intersection point) from a frame to an intersection point of a primary ray and the primitive with respect to pixels included in the tiles, and stores depth values of intersection points calculated for each pixel in the depth buffer 440.

The tag buffer 425 outputs the visible primitive information to a rasterizer 431. The rasterizer 431 splits a primitive output by the tag buffer 425 into fragments and outputs the split fragments to the depth test unit 435.

The depth test unit 435 performs a depth test on the fragments by using the depth values stored in the depth buffer 440, and determines whether the fragments are visible. The pixel shader 437 performs pixel shading for determining color values of the output fragments.

The tile buffer 450 stores final pixel values of the plurality of pixels included in the tiles.

If the pixel values of the plurality of pixels included in the tiles are determined, the tiles are output to the frame buffer 330.

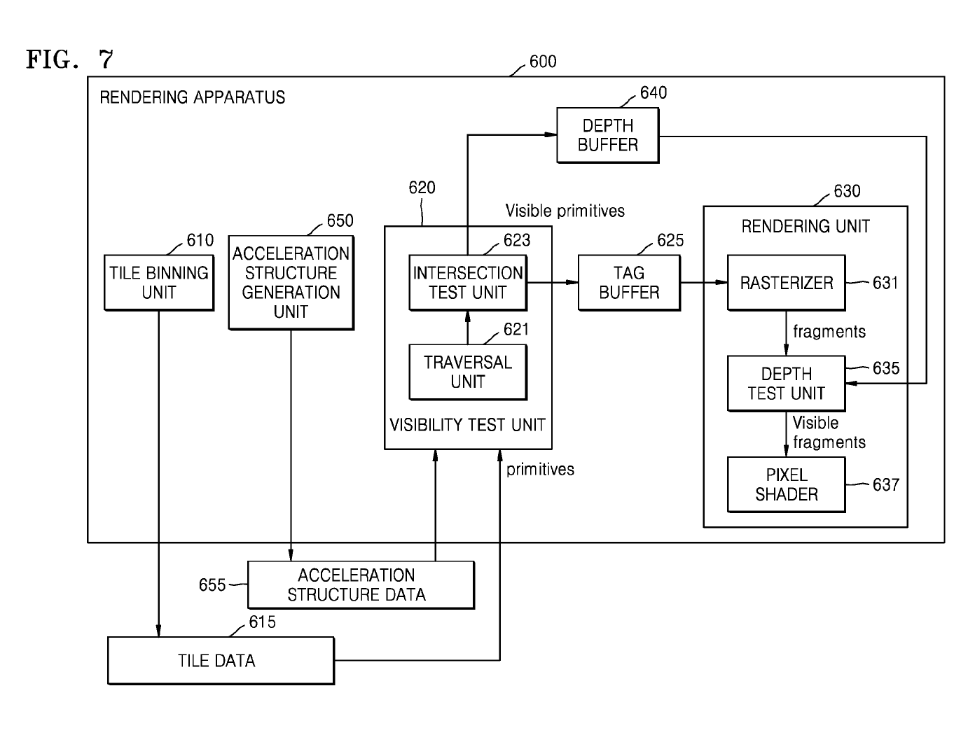

FIG. 7 is a block diagram illustrating a structure of a rendering apparatus 600 according to another embodiment.

Referring to FIG. 7, the rendering apparatus 600 includes a tile binning unit 610, an acceleration structure generation unit 650, a visibility test unit 620, a tag buffer 625, a depth buffer 640, and a rendering unit 630. The visibility test unit 620 includes a traversal unit 621 and an intersection test unit 623. The rendering unit 630 includes a rasterizer 631, a depth test unit 635, and a pixel shader 637. The tile binning unit 610, the tag buffer 625, the depth buffer 640, and the rendering unit 630 of FIG. 7 may correspond to the tile binning unit 310, the tag buffer 325, the depth buffer 340, and the rendering unit 330 of FIG. 5. Thus, the tile binning unit 610, the tag buffer 625, the depth buffer 640, and the rendering unit 630 are described in detail with reference to FIG. 5, and thus detailed descriptions thereof are omitted.

The acceleration structure generation unit 650 generates an acceleration structure indicating location information of primitives included in tiles. The acceleration structure generation unit 650 may split a space corresponding to each of the tiles in a hierarchical tree shape and may generate the acceleration structure according to the tiles. In this regard, the acceleration structure generation unit 650 may generate various types of acceleration structures. For example, the acceleration structure generation unit 650 may generate the acceleration structure indicating relationships between primitives on a 3D space by applying a K-dimensional (KD) tree, a bounding volume hierarchy (BVH), etc. The acceleration structure generation unit 650 may generate the acceleration structure by applying an axis-aligned bounding volume (AABB) used to perform tile binning.

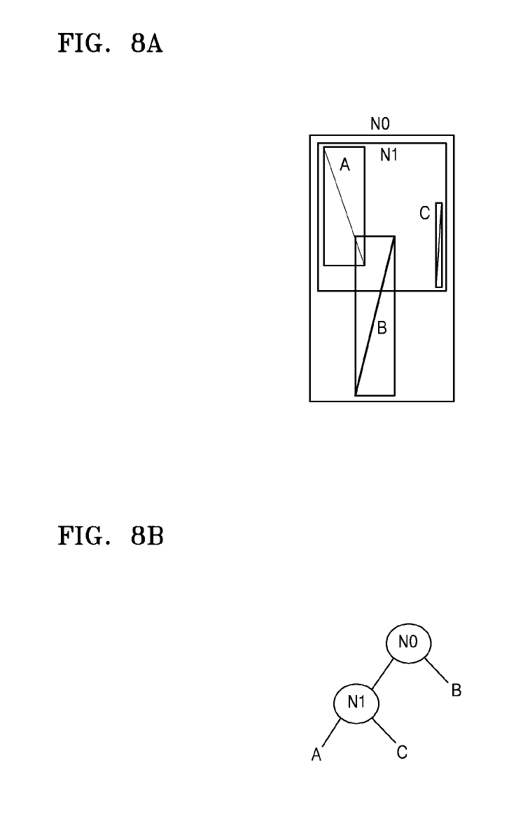

For example, the acceleration structure generation unit 650 may split spaces corresponding to tiles of FIGS. 4A and 4B hierarchically as shown in FIG. 8A, thereby generating an acceleration structure as shown in FIG. 8B. The acceleration structure may include a node that may be a hierarchically split area. The node may include a top node, an inner node, a leaf node, etc. For example, N0 denotes the top node, and N1 denotes the leaf node. The node may be in a rectangular shape as shown in FIG. 8A but is not limited thereto.

The acceleration structure generation unit 650 stores data (acceleration structure data 655) regarding the generated acceleration structure in an external memory.

Referring to FIG. 7, the traversal unit 621 detects a node which a generated ray intersects based on the acceleration structure data 655. The traversal unit 621 may detect a leaf node which each of generated rays intersects with respect to the pixels included in the tiles. For example, the traversal unit 621 may detect the leaf node N1 which the ray R0 generated with respect to a first pixel of FIG. 4A intersects.

The intersection test unit 623 receives the leaf node which the ray intersects from the traversal unit 621, and performs an intersection test between the ray and primitives included in the received leaf node by using information regarding the primitives. The intersection test unit 623 may test to determine which one of the plurality of primitives included in the received leaf node the ray intersects. For example, the intersection test unit 623 may test with which one of the first primitive A and the third primitive C included in the leaf node N1 the ray R0 generated with respect to the first pixel of FIG. 4A intersects.

The intersection test unit 623 detects primitives with which the ray intersects and calculates hit points at which the detected primitives and the ray intersect. In this regard, the detected primitives are stored in the tag buffer 625, and a depth value of the hit point is stored in the depth buffer 640.

The rendering unit 630 performs rendering on a visible primitive stored in the tag buffer 625. For example, the rasterizer 631 may split the visible primitive into fragments. The depth test unit 635 may perform a visibility test on the primitive by using the depth value stored in the depth buffer 640. The pixel shader 637 may determine a color value of a visible fragment.

As described above, the rendering apparatus 600 according to an embodiment performs a visibility test on a primitive by using an acceleration structure, thereby reducing an arithmetic operation necessary for the visibility test.

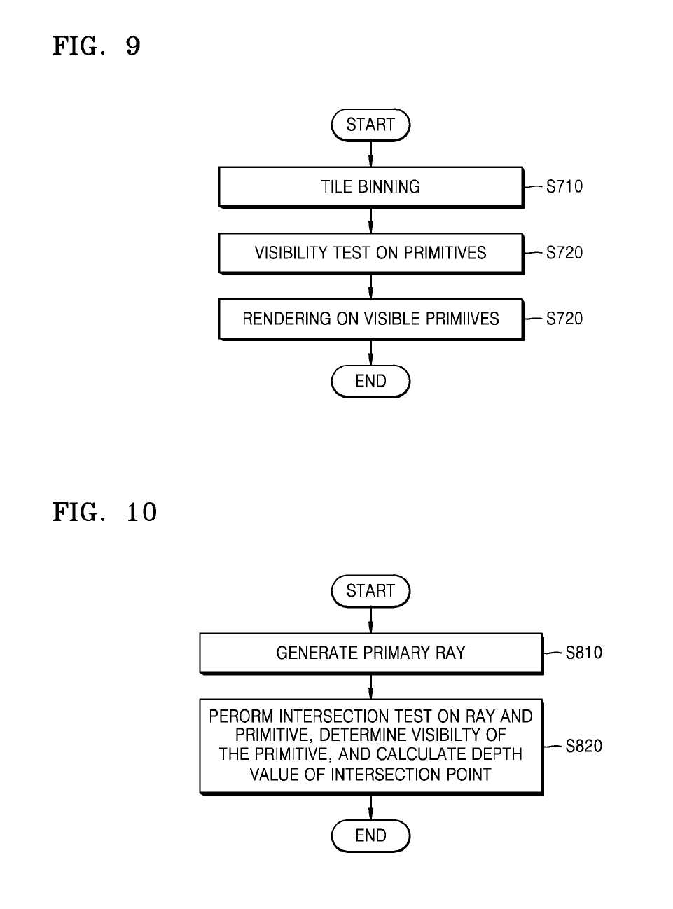

FIG. 9 is a flowchart describing a rendering method according to an embodiment.

Referring to FIG. 9, the rendering apparatuses 100, 300, 400, and 600 bin a plurality of tiles included in a 2D frame (operation S710).

Tile binning means discrimination of tiles including at least one primitive included in an object. The rendering apparatuses 100, 300, 400, and 600 bin the plurality of tiles by determining which one of the plurality of tiles included in the 2D frame includes a primitive included in an object based on information regarding the primitive. The rendering apparatuses 100, 300, 400, and 600 generate tile data (for example, 220 of FIG. 3) including primitive information included in each tile.

The rendering apparatuses 100, 300, 400, and 600 perform a visibility test on a primitive included in each of the plurality of tiles (operation S720).

The rendering apparatuses 100, 300, 400, and 600 may perform the visibility test on the primitive included in each of the plurality of tiles by using a ray tracing method. Operation S720 will be described with reference to FIG. 10 below.

FIG. 10 is a flowchart for describing operation S720 of FIG. 9 according to an embodiment.

Referring to FIG. 10, the rendering apparatuses 100, 300, 400, and 600 generate a primary ray with respect to each of a plurality of pixels included in a tile (operation S810).

The rendering apparatuses 100, 300, 400, and 600 perform an intersection test of generated primary rays and primitives included in a corresponding tile, determine visibility of the primitives, and calculate a depth value of an intersection point (operation S820).

The rendering apparatuses 100, 300, 400, and 600 may detect a primitive which the primary ray intersects for each pixel, determine visibility of the primitive, and calculate a depth value of an intersection point of the primary ray for each pixel. The rendering apparatuses 100, 300, 400, and 600 may store the detected primitive (visible primitive) in a tag buffer and store the depth value of the intersection point in a depth buffer.

Referring to FIG. 9, the rendering apparatuses 100, 300, 400, and 600 may render the visible primitive (operation S730).

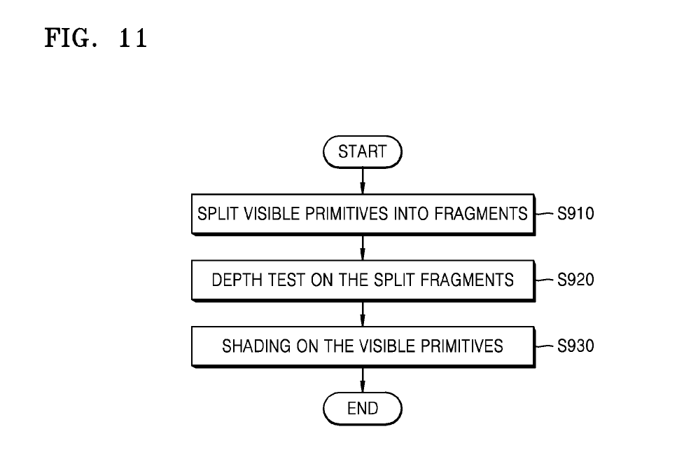

Operation S730 will be described with reference to FIG. 11 below.

FIG. 11 is a flowchart for describing operation S730 of FIG. 9 according to an embodiment.

Referring to FIG. 11, the rendering apparatuses 100, 300, 400, and 600 split a visible primitive into a plurality of fragments (operation S910).

The rendering apparatuses 100, 300, 400, and 600 perform a depth test on the split fragments (operation S920).

The rendering apparatuses 100, 300, 400, and 600 may perform the depth test on the split fragments by using depth values calculated in operation S820 of FIG. 10. The rendering apparatuses 100, 300, 400, and 600 may compare depth values of the fragments and the calculated depth values to test whether a corresponding fragment is visible. For example, when the depth values of the fragments and the calculated depth values are identical to each other, the rendering apparatuses 100, 300, 400, and 600 may determine that the corresponding fragment is a visible fragment. However, the determination of a visible fragment is not limited to this specific operation.

The rendering apparatuses 100, 300, 400, and 600 may perform pixel shaping of determining a color value of the visible fragment (operation S930) based on the depth test.

As described above, according to the one or more of the above embodiments, a visibility test is performed on a primitive, thereby removing an unnecessary arithmetic operation and generating power consumption.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments. The media may also be a distributed network, so that the computer readable code is stored/transferred and executed in a distributed fashion. Examples of computer readable code include machine code, such as produced by a compiler, and files containing higher level code that may be executed by the computer using an interpreter. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described “unit” to perform an operation or a method may be hardware, software, or some combination of hardware and software. For example, the unit may be a software package running on a computer or the computer on which that software is running.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present inventive concept have been described with reference to the figures, it will be understood by those of ordinary skill in the art that various changes in form and details may be made therein without departing from the spirit and scope of the present inventive concept as defined by the following claims.

What is claimed is:

1. A rendering apparatus comprising:
a tile binning unit configured to determine a plurality of tiles comprising at least one primitive, and configured to generate tile data associated with the plurality of tiles;
a visibility test unit configured to perform a visibility test on the at least one primitive included in the plurality of tiles, based on the tile data; and a rendering unit configured to perform rendering on a visible primitive among the at least one primitive as a result of the visibility test.

2. The rendering apparatus of claim 1, wherein the visibility test unit is configured to generate a ray with respect to each pixel among a plurality of pixels included in a respective tile among the plurality of tiles, perform an intersection test on the generated ray and a primitive, among the at least one primitive, included in the respective tile, and determine whether the primitive included in the respective tile is visible.

3. The rendering apparatus of claim 2, wherein the visibility test unit is configured to obtain at least one of primitive information about one or more primitives, among the at least one primitive, which the ray intersects and a depth value of a point which the ray intersects.

4. The rendering apparatus of claim 3, further comprising a tag buffer configured to store the primitive information about the one or more primitives which the ray intersects.

5. The rendering apparatus of claim 3, further comprising a depth buffer configured to store the depth value of the point which the ray intersects.

6. The rendering apparatus of claim 1, further comprising an acceleration structure generation unit configured to generate an acceleration structure with respect to each of the plurality of tiles, wherein the visibility test unit is configured to perform the visibility test on the at least one primitive included in the plurality of tiles based on the generated acceleration structure.

7. The rendering apparatus of claim 1, wherein the rendering unit comprises:
a rasterizer configured to split the visible primitive into fragments; and
a pixel shader configured to determine color values of the split fragments.

8. The rendering apparatus of claim 7, wherein the rendering unit further comprises a depth test unit configured to perform a depth test on the split fragments.

9. The rendering apparatus of claim 8, wherein the visibility test unit is configured to generate a ray with respect to each pixel among a plurality of pixels included in a respective tile, among the plurality of tiles, perform an intersection test on the generated ray and a primitive, among the at least one primitive, included in the respective tile, and obtain a depth value of a point which the ray intersects, and wherein the depth test unit is configured to perform a depth test on the split fragments based on the depth value of the point which the ray intersects.

10. A rendering method comprising:
determining, using at least one processor, a plurality of tiles comprising at least one primitive and generating tile data associated with the plurality of tiles;
performing, using the at least one processor, a visibility test on the at least one primitive included in the plurality of tiles based on the tile data; and
performing, using the at least one processor, rendering on a visible primitive, among the at least one primitive, as a result of the visibility test.

11. The rendering method of claim 10, wherein the performing of the visibility test comprises:
generating a ray with respect to each pixel among a plurality of pixels included in a respective tile among the plurality of tiles;
performing an intersection test on the generated ray and a primitive, among the at least one primitive, included in the respective tile; and
determining whether the primitive included in the respective tile is visible.

12. The rendering method of claim 11, wherein the performing of the visibility test comprises:
obtaining at least one of primitive information about one or more primitives, among the at least one primitive, which the ray intersects and a depth value of a point which the ray intersects.

13. The rendering method of claim 12, further comprising:
storing the primitive information about the one or more primitives which the ray intersects.

14. The rendering method of claim 12, further comprising:
storing the depth value of the point which the ray intersects.

15. The rendering method of claim 10, further comprising:
generating, using the at least one processor, an acceleration structure with respect to each tile of the plurality of tiles,
wherein the performing of the visibility test comprises performing the visibility test on the at least one primitive included in the plurality of tiles based on the generated acceleration structure.

16. The rendering method of claim 10, wherein the performing of the rendering comprises:
splitting the visible primitive into fragments; and
determining color values of the split fragments.

17. The rendering method of claim 16, wherein the performing of the rendering further comprises performing a depth test on the split fragments.

18. The rendering method of claim 17, wherein the performing of the visibility test comprises:
generating a ray with respect to each pixel among a plurality of pixels included in a respective tile among the plurality of tiles;
performing an intersection test on the generated ray and a primitive included in the respective tile;
obtaining a depth value of a point which the ray intersects; and
performing the depth test on the split fragments based on the depth value of the point which the ray intersects.

19. A computer-readable recording medium having a program recorded thereon and configured to execute the method of claim 10.
